(19) United States
(12) Patent Application Publication
(10) Pub. No.: US 2010/0147408 A1
(43) Pub. Date: Jun. 17, 2010

(54) SEWER PIPE FLOW THROUGH BYPASS DEVICE

(76) Inventor: Vernon L. Tyson, Durham, NC (US)

Correspondence Address: PASSE' INTELLECTUAL PROPERTY, LLC, 1717 BRASSFIELD RD., RALEIGH, NC, 27614, US

(21) Appl. No.: 12/333,552

(22) Filed: Dec. 12, 2008

(51) Int. Cl. F16L 55/11

(52) U.S. Cl. 138/40; 138/89; 405/184.2

(57) ABSTRACT

The present invention relates to a bypass device for bypassing a sewer where it exits a building. The device comprises a pass through pipe having one or more compression rings which expand under compression to seal the hollow pipe in place in a pipe exiting to a sewer.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method of bypassing the main sewer when sewage exits a building or other sewage normally flushed to the main sewer. In particular the present invention is a sewer bypass device which allows the sewage from a sewage exit port to be rerouted or plugged and thus not exit into the larger main sewer.

2. Description of Related Art

When working on a sewer line that has active effluent sewage being deposited from surrounding buildings it is necessary in some cases to stop or divert that sewage from flowing in the sewer line in order to complete some types of work. Sewage from individual buildings continues to be flushed into the main pipeline unless other arrangements are made to divert or stop flowage. This is especially true when a sewer is to be relined or coated. The pipeline usually must be dried out and remain dry for a period of time before recoating.

Further when testing sewer lines or pipes it is frequently necessary to plug the line to test for things such as pressure related leaks or the like. One or both ends of a sewer pipe are normally temporarily sealed and pressure added to the system.

One way of dealing with these problems is to inform users to not flush during the process or to plug up the effluent pipes. However, that is usually unacceptable since in the case of homes and businesses those facilities need to be available for continuous use and in the case of businesses must remain available or the business must close.

Bypass plugs have been used for some time. In most embodiments these consist of an inflatable device, usually bias tire cord, which is inflated to a given inflation pressure. The bias tire cord conforms to the inner surface of the sewer pipe and attempts to seal the pipe. These types of devices, however, suffer from a number of problems. In particular the inflated portion of the plug or bypass can pop during use. There is no good way to see when a failure is coming so when such failures occur it is usually a costly and messy event. In addition the inflatable devices can slowly leak leading to failure over a period of time, even though they initially form a tight seal in the sewer pipe. The devices also require use of some form of pump which if that fails, renders the device unusable. The devices also suffer from being relatively heavy and costly to purchase. They are not repairable and must be replaced at frequent intervals to prevent failures.

A number of different devices are described in diverting effluent and the like in the art. U.S. Pat. No. 3,401,720 to Telford issued Sep. 17, 1968 discloses an inflatable packer between a sewer line and a wedging element. U.S. Pat. No. 4,365,649 to Jones issued Dec. 28, 1982 discloses a sewer pipe plug with an inflatable tube carried by the outer sleeves. U.S. Pat. No. 4,980,116 to Driver issued Dec. 25, 1990 discloses a bypass conduit having a pump to move effluent. U.S. Pat. No. 5,736,166 to Polivka issued Apr. 7, 1998 discloses a flow through device comprising an expandable bladder interior sealing attached to the interior of a tubular body to form a pressure chamber to inflate the bladder to close the end of a liner. As can be seen these devices are either not adequate for the task or rely on inflation or motorized pumping devices in order to accomplish the task of sealing or diverting effluent.

Accordingly the present state of the art is such that it inadequately provides for a safe and effective solution to the sealing or diverting of effluent from a sewer pipe opening or other pipe opening. In addition as can be seen from these devices that they represent an expensive and time consuming way to seal or divert effluent and cheaper and easier methods would clearly be of great advantage to one skilled in the art.

### BRIEF SUMMARY OF THE INVENTION

The present invention relates to a sewer bypass or plug which solves many of the problems of the prior art devices. In particular it relates to use of o rings which expand and seal the inside of the pipe. The can be sized directly to the sewer pipe being used, can be easily repaired, and do not require use of a separate pump.

In particular the invention, in one embodiment, relates to a sewer bypass device for use in a sewer pipe opening of a first inner diameter comprising:
a) a hollow pipe having a first end for positioning upstream in the sewer pipe opening and a second end, the first end having an outer diameter smaller than the sewer pipe first inner diameter;
b) at least two compression plates designed to be positioned on the hollow pipe outer diameter each plate having an outer diameter smaller than the first inner diameter;
c) at least one compression ring wherein each ring is positioned on the outer diameter of the hollow pipe, in-between two compression plates, and having an uncompressed outer diameter smaller than the sewer pipe's first inner diameter but which has an outer diameter larger than the sewer pipe's first inner diameter when compressed between the two compression plates;
d) a compression collar for compressing the compression plates; and
e) a sewer flow diverter attachment collar for attaching a sewer flow diverter pipe in fluid communication with the second end of the hollow pipe.

In another embodiment the present invention relates to a method of diverting the flow exiting a sewer pipe opening of a first inner diameter comprising:
a) selecting a hollow pipe having a first and second end and the first end having an outer diameter less than the first inner diameter wherein there is at least one compression ring having an outer diameter less than the first inner diameter fitted on the hollow pipe outer diameter;
b) positioning the first end of the hollow pipe in the sewer pipe opening sufficient that the at least one compression ring is also positioned in the sewer pipe;
c) compressing the at least one compression ring such that the compression ring expands to form a seal between the compression ring and the first inner diameter; and
d) attaching a diverter pipe to the hollow pipe second end.

### BRIEF DESCRIPTION OF THE DRAWINGS

FIG. 1 is a side view of a device of the present invention.

FIG. 2 is an upstream angle perspective view of a device of the present invention.

FIG. 3 is a downstream angle perspective view of a device of the present invention.

FIG. 4 is an exploded view of a device of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein a “sewer bypass device” is a device for diverting the effluent of a sewer into a larger sewer pipe, for example, sewer pipes exiting houses and depositing into the main sewer pipe line. It is also a device that can be used in some instances and embodiments to plug the sewer effluent completely as an alternate means of preventing effluent from depositing in a main sewer. The sewer pipe that the device is used on will have an outer diameter and an “inner diameter” where the device is positioned during use. It will be positioned in an opening in the pipe where it joins a larger sewer pipe. As used herein that inner diameter is referred to as a sewer pipe opening of a first inner diameter. The inner diameter defines the space that effluent travels during the sewer pipe use. Note that while the intended uses for the bypass device is described above the device can be used to divert flow from an pipe of any given inner diameter. Therefore, a water drainage pipe or other type round pipe could be diverted or plugged with the device of the present invention just by matching the device to the pipe inner diameter.

The sewer bypass device has a hollow pipe designed for diverting the effluent from the sewer pipe. The hollow pipe has a first and second end and is of a selected length determined by the sewer being diverted its diameter and one skilled in the art would be able to determine its length from the use information herein. The hollow pipe has a first end and a second end wherein liquid entering the first end can travel through the hollow pipe and exit the second end. Typically, the pipe can be a plastic or metal type pipe but any material suitable for the intended bypass use of the materials could be used. The inner diameter of the hollow pipe could also be treated or coated to further resist the corrosive effects of any effluent passing through the hollow tube. The size of the pipe, i.e. the outer diameter, is smaller than the inner diameter of the sewer pipe such that the entire device will easily fit into the sewer pipe opening. The first end would be stuck upstream into the opening while the second end would protrude from the opening for example, into the main sewer (by sewer is also meant “manhole”, “wet well,” “pumping station” or the like where the sewer pipe empties into. The inner diameter of the hollow pipe should be as large as possible after determining the proper outer diameter. Much of the details will be dictated by the materials chosen to fabricate the hollow pipe but maximizing the inner diameter maximizes the amount of effluent the hollow pipe can divert from the sewer pipe.

Next the device of the present invention has at least two compression plates positioned on the hollow pipe outer diameter. The inner diameter of the compression plate fits over the outer diameter of the hollow pipe and the outer diameter of the compression plate is less than the inner diameter of the sewer pipe. In some embodiments the compression plate is just slightly smaller than the inner diameter of the sewer pipe to make a snug fit. This will be useful as will be seen following.

Positioned in between the compression plates is a compression ring (or compressible plate). The compression ring is also fitted with its inner diameter over the outer diameter of the hollow pipe and the outer diameter of the compression ring small enough to fit into the sewer pipe's inner diameter. Note one again that a snug fit is contemplated in one embodiment. The compression ring is made of a material that when compressed between the compression rings increases its outer diameter. In other words, when in an uncompressed state, it has a first outer diameter and when compressed between the compression plates, it has a larger outer diameter than the inner diameter of the sewer pipe (when the device is not in the sewer pipe). When inserted in a sewer pipe, the compression ring attempts to have a diameter larger than the inner diameter of the sewer pipe and thus forms a seal within the sewer pipe inner diameter. Compressing a rubber material, or any other elastomeric, compressible material is contemplated within the scope of the invention. By compressing the compression plates such that they compress the compression ring and enlarge the compression ring outer diameter, the compressed compression ring will increase from a loose or snug fit to a water tight seal within a sewer pipe. It is clear that the relative size of the device compared to the inner diameter of the sewer pipe will depend on the material used and a number of different factors obvious in view of this disclosure and one skilled in the art would be able to determine without undue experimentation the exact sizes and optimum materials for making the compression rings.

While use of one compression ring in between two compression plates is contemplated, multiple compression rings are as well, and increasing the number also increases the fit and decreases the likelihood of a leak. Therefore, in some embodiments there could be 2, 3, 4, 5 or more compression rings. The specific embodiment in the figures which follow show 3 compression rings. In other embodiments there could be multiple compression rings in between each pair of compression plates. In embodiments of the invention both the compression plates and compression rings slide on the hollow pipe outer diameter freely during the compression process.

The present invention includes a compression collar. A compression collar is any device which can be used to compress the compression plates, to expand the compression ring and seal the bypass device in place. In one embodiment it comprises a two piece device comprising a fixed in place member and a moving member positioned on either side of the compression plates. By moving the moving plate toward the fixed in place member the compression plates are compressed. In one embodiment of the present invention the hollow tube is threaded. A fixed member is attached by gluing in place on the upstream first end of the hollow pipe. Next is positioned the compression plates and compression ring(s). Lastly, the movable compression collar plate is added. In one embodiment it is screwed onto the second end of the hollow pipe until it is up against the downstream most compression plate. Once the compression collar movable plate is tightened farther it will compress the compression plates. Tightening can be done by hand, by a lever, or the like or any other method of tightening a screw.

Once the device is in place in the sewer opening and secured in a sealed manner, the flow coming from upstream in the sewer will flow through the hollow pipe. One of two things can be done at this point. The downstream side of the hollow pipe can be sealed, for example, by screwing on a cap on the second end of the hollow pipe thus creating a sealed plug. Where the device is to be used as a flow through device a flow diverter attachment collar is placed on the second end of the hollow pipe. In the embodiment where the hollow pipe has screw teeth, the attachment collar can be screwed on the end. Then, a diverter pipe in some embodiments a flexible pipe or conduit can be attached of any desired length and the effluent coming through the hollow tube will end up in the diverter pipe and out of the sewer or other area where flow is being diverted. The connection to the diverter collar can be by quick connect means, screw means or any other attachment means and such means are known within the art. In some embodiments the compression movable collar portion is the same as the diverter attachment collar.

Some optional features of the present device include making the diverter of a transparent material to be able to view flow through the device and determine how the device is working or not working. Other embodiments include an upstream funnel to help prevent blockages. An upstream funnel provides gradual and smooth compaction of flow into the device, so that it is not easy for solids to only partially enter the device and thereby cause a “logjam” effect.

In use, the device is placed in the sewer pipe opening first end up stream until all the compression rings are inside the inner diameter of the sewer. The compression rings are then compressed and by use of the compression collar held in the position as long as the device is desired to seal the opening. Finally, either a plug cap or a diverter hose is attached to the second end of the device thus completing a plugging or diverting of the effluent in the sewer pipe.

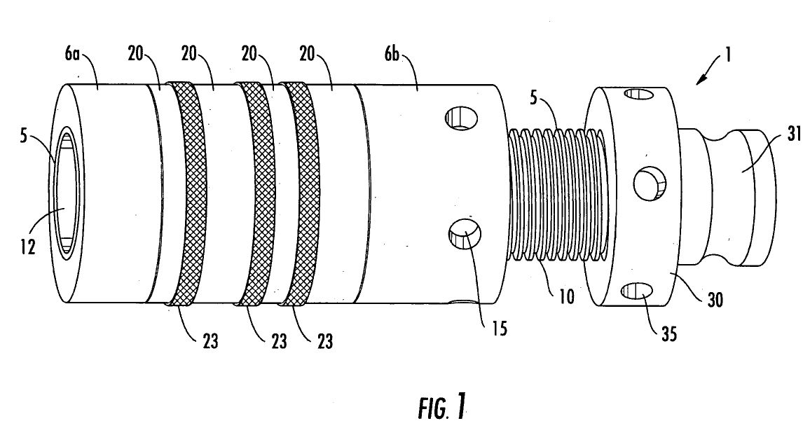

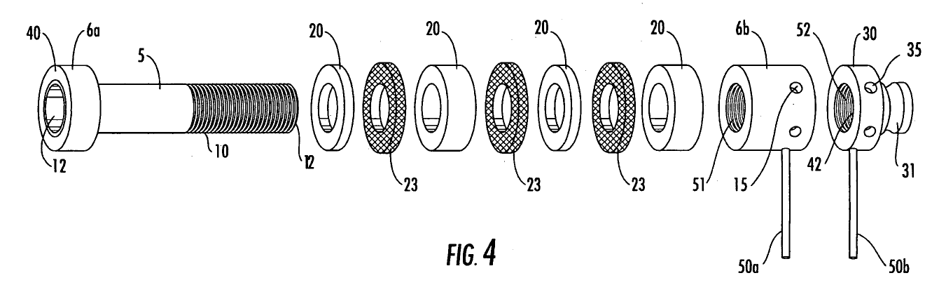

Now referring to the drawings, FIG. 1 is a side perspective of a sewer bypass device 1 of the present invention. The hollow pipe 5 of the present invention is depicted having threads or teeth 10 on its outer diameter and also has an inner diameter 12. In this embodiment, the compression collar is depicted by fixed member 6a and movable member 6b wherein movable member 6b can be screwed toward fixed member 6a on the threads 10 on the hollow pipe 5. In this embodiment the movable member could be screwed in place by hand but in order to gain leverage and insure a proper compression leverage holes 15 are provided. One can position a rod in one or more of the holes 15 and use the rod to twist the movable member 6b to the proper position. For example, see FIG. 4 for rod positioning.

Positioned on hollow pipe 5 in between fixed member 6a and movable member 6b are compression plates 20 interspersed with compression rings 23. As compression rings are squeezed with the compression collar 6a and 6b the compression rings 23 which are shown with a slightly larger diameter than the compression plates 20, are expanded in diameter as they are compressed between the plates 20. This way a seal is formed between the compression rings and the inner diameter of a sewer pipe as the compression rings 23 press against the pipe.

Sewer flow diverter 30 is shown screwed on to the second end of hollow pipe 5. The sewer flow diverter 30 comprises attachment collar 31 for attaching a diverter pipe to take effluent from this end of the device and move it to a desired location. On the side of the sewer flow diverter 30 are rod holes 35 for placing a rod into to tighten the collar onto the hollow pipe 5 similar to the compression collar 6b.

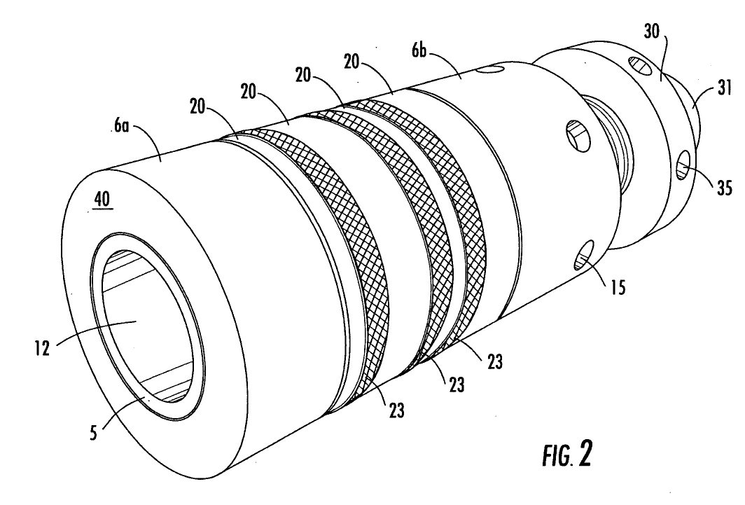

FIG. 2 shows the same device 1 from an angled perspective with the upstream end 40 positioned forward. This view allows one to see the inner diameter 12 of the hollow pipe 5 which defines the hollow portion of the hollow pipe 5. This inner hollow portion carries effluent from upstream and since it is in fluid communication with the downstream end of the hollow tube delivers effluent out the attachment collar 31.

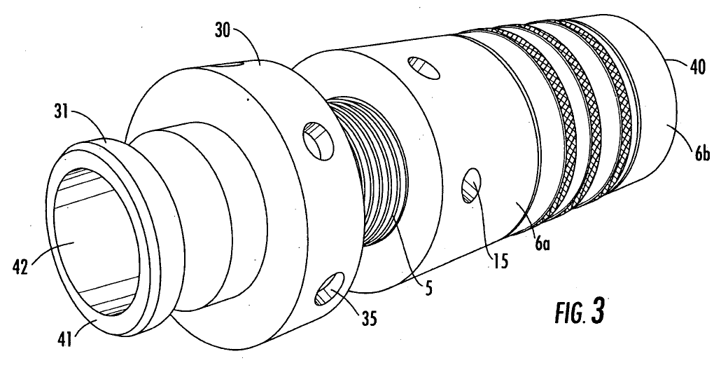

FIG. 3 shows the same device 1 however this time in angled perspective from the downstream end 41 of the device 1. The inner diameter 12 of the hollow pipe 5 is in fluid communication with an inner diameter 41 of the attachment collar so that effluent passes from the hollow pipe to the attachment collar and off to any pipe attached to it in fluid communication.

FIG. 4 is an exploded view of the device 1. In this view on can clearly see that teeth 10 extend only on the outer diameter of hollow tube 5 for about half its length on the downstream side of the tube. This is done mainly because the items that screw on to the hollow tube 5 do not need to pass any further down the length of the tube. One would clearly not place teeth (threads) the entire length of the tube since this would prevent a seal between the compressible plate and the pipe. The compression plates 20 are shown and have varying widths and the compression rings 23 placed in between the series of compression plates. Each of their inner diameters are smooth to aid in sliding on the outer diameter of the hollow tube 5 during compression.

In this view the inner diameters of the movable compression collar 6b can be seen with threads 51 which match the threads 10 of the hollow tube 5. Likewise the sewer flow diverter 30 has an inner diameter which has threads 52 matching the threads of hollow tube 5. The tapered design of the sewer flow diverter 30 means that when the diverter 30 narrow portion reaches the downstream end of the tube it will not move any farther and be fully installed. Note that the sewer flow diverter could also be an end cap that screws on in place and seals a sewer opening instead of diverting the effluent.

Lastly, rods 50a and 50b are shown in a hole 15 and 35 respectively. As discussed above rods 50a and 50b can be used to tighten the collar 6a and diverter 30 respectively. While a single rod can be used and switched between these positioned the use of two rods as depicted in the drawing would enable one to twist the rods in opposite directions to get even more leverage on rod 50a than twisting with a single rod or by hand.

The above embodiments are not intended to be limiting. Other means for compression, selection of materials and the like is within the skill in the art. Likewise attachment of a diverter pipe is well within the skill in the art as is an end cap, tightening means and the like. the claims which follow are therefore not to be construed to be limited by the embodiments.

What is claimed is:

1. A sewer bypass device for use in a sewer pipe opening of a first inner diameter comprising:
a) a hollow pipe having a first end for positioning upstream in the sewer pipe opening and a second end, the first end having an outer diameter smaller than the sewer pipe first inner diameter;
b) at least two compression plates designed to be positioned on the hollow pipe outer diameter each plate having an outer diameter smaller than the first inner diameter;
c) at least one compression ring wherein each ring is positioned on the outer diameter of the hollow pipe, in-between two compression plates, and having an uncompressed outer diameter smaller that the sewer pipe's first inner diameter but which has an outer diameter larger than the sewer pipe's first inner diameter when compressed between the two compression plates;
d) a compression collar for compressing the compression plates; and
e) a sewer flow diverter attachment collar for attaching a sewer flow diverter pipe in fluid communication with the second end of the hollow pipe.

2. A device according to claim 1 wherein there are 2 or more compression rings and 3 or more compression plates.

3. A device according to claim 1 wherein the attachment collar is on the compression collar.

4. A device according to claim 1 wherein the sewer flow diverter collar has a quick connect fitting.

5. A device according to claim 1 wherein there is at least a portion of the device is made of a transparent material.

6. A device according to claim 1 which further comprises a funnel for positioning upstream of the device designed to prevent blockages.

7. A device according to claim 1 wherein the hollow pipe can be sealed such the device can be used as a sewer plug.

8. A device according to claim 1 wherein the compression collar consists of a fixed member positioned on the upstream outer diameter of the hollow pipe and a movable member positioned on the downstream outer diameter of the hollow pipe with the compression plates and compression rings positioned in between the fixed and movable members and wherein the movable member can move toward the fixed member and compress the compression plates.

9. A method of diverting the flow exiting a sewer pipe opening of a first inner diameter comprising:
a) selecting a hollow pipe having a first and second end and the first end having an outer diameter less than the first inner diameter wherein there is at least one compression ring having an outer diameter less than the first inner diameter fitted on the hollow pipe outer diameter;
b) positioning the first end of the hollow pipe in the sewer pipe opening sufficient that the at least one compression ring is also positioned in the sewer pipe;
c) compressing the at least one compression ring such that the compression ring expands to form a seal between the compression ring and the first inner diameter; and
d) attaching a diverter pipe to the hollow pipe second end.

10. A method according to claim 9 wherein the at least one compression ring is compressed between two or more compression plates.

11. A method according to claim 9 wherein the compression plates are compressed by positioning a compression collar on the hollow pipe and compressing the compression plates.

12. A method according to claim 11 wherein the compression collar comprises a fixed member and a movable member positioned on either side of the compression plates wherein the movable member is moved toward the fixed member to compress the compression plates.

13. A method according to claim 9 where the diverter pipe is sealed and the device used to plug the sewer pipe.
